(19) United States
(12) Patent Application Publication
(10) Pub. No.: US 2007/0212996 A1
(43) Pub. Date: Sep. 13, 2007

(54) Manual coin sorter

(76) Inventor: Jeong Suk Ryou, Seoul (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/374,558

(22) Filed: Mar. 13, 2006

(51) Int. Cl. G07D 3/00

(52) U.S. Cl. 453/13

(57) ABSTRACT

A manual coin sorter includes an outer case, a handle operated by a user and formed on a side portion of the outer case, a rotational shaft to which rotational force of the handle is transmitted, a driving shaft to which rotational force of the rotational shaft is transmitted, the driving shaft is disposed with a predetermined axis angle with the rotational shaft, a conveying container rotatably coupled to the driving shaft and provided with a plurality of conveying holes on which coins are disposed and conveyed, a seating part provided with a plurality of sorting holes having a different diameter, the coins being dropped to the sorting holes when the sorting holes are aligned with the conveying holes, and a coin receiving tube in which the coins dropped from the seating part are received and stacked.

### BACKGROUND OF THE INVENTION

1. Field of the Invention

The present invention relates to a manual coin sorter, and more particularly, to a manual coin sorter having a simple mechanical structure, which is designed to conveniently sort coins by manually operating a handle without using outer electric power.

2. Description of the Related Art

Generally, a coin is a small metal disc stamped for use as currency together with paper money. Coins are designed having a different size according to their value of currency. A coin sorter is used to sort such coins using the difference of the coin size. Such a coin sorter is also used at home to sort coins collected by children so as to make the children interested in saving, providing the education effect.

A conventional coin sorter includes a coin sorting unit for classifying coins by size and a coin receiving unit for allowing the coins to be received in corresponding receiving tubes. That is, when the coins are classified by the coin sorting unit, the coin size functions as focal classification components. The coin receiving tubes are provided to correspond to the coin sizes. That is, the coins are classified by size and stacked in the size-corresponding receiving tubes so that the user can conveniently use the coins.

Since the conventional coin sorter is designed to automatically operate by outer electric power, it is relatively expensive to manufacture. That is, since the coin sorting and receiving units are automatically operated by a motor, the overall size of the coin sorter is increased, thereby increasing the manufacturing costs. Furthermore, it is difficult for the children to operate the sorter, deteriorating the education effect.

Such an automatic coin sorter is disclosed in Korean Patent Application No. 10-2002-0059590 filed by the applicant of this application and entitled to “Coin Sorter.”

U.S. Pat. No. 5,443,419 discloses a coin sorter that is designed to manually sort the coins. However, since a coin sorting unit is designed to be operated by the self-gravity dropping operation, there may be frequent operation errors and the education effect is deteriorated.

### SUMMARY OF THE INVENTION

Accordingly, the present invention is directed to a manual coin sorter that substantially obviates one or more problems due to limitations and disadvantages of the related art.

An object of the present invention is to provide a manual coin sorter that can sort coins by simply rotating a handle.

Another object of the present invention is to provide a manual coin sorter that is designed to be operated by a simple mechanical structure without using outer electric power, thereby reducing an overall size of the manual coin sorter as well as the manufacturing costs.

Still another object of the present invention is to provide a manual coin sorter that is designed to sort coins using predetermined outer force and to allow a user to observe the sorting operation, thereby improving an education effect for children and preventing the malfunction.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a manual coin sorter comprising an outer case; a handle operated by a user and formed on a side portion of the outer case; a rotational shaft to which rotational force of the handle is transmitted; a driving shaft to which rotational force of the rotational shaft is transmitted, the driving shaft is disposed with a predetermined axis angle with the rotational shaft; a conveying container rotatably coupled to the driving shaft and provided with a plurality of conveying holes on which coins are disposed and conveyed; a seating part provided with a plurality of sorting holes having a different diameter, the coins being dropped to the sorting holes when the sorting holes are aligned with the conveying holes; and a coin receiving tube in which the coins dropped from the seating part are received and stacked.

In another aspect of the present invention, there is provided a manual coin sorter comprising: a handle rotatably installed on an outer case; a rotational shaft rotated by the handle; a driving shaft connected to the rotational shaft with a predetermined axis angle; a coin sorting unit rotated by the driving shaft to sort the coins by size; and a coin receiving unit for receiving the sorted coins.

In a still another aspect of the present invention, there is provided a manual coin sorter comprising a handle rotatably installed on an outer case; a rotational shaft rotated by the handle; a driving shaft connected to the rotational shaft with a predetermined axis angle; a coin input part provided on an upper portion of the outer case; a conveying container rotatably coupled to the driving shaft and provided with a plurality of conveying holes on which coins are disposed and conveyed; a seating part provided with a plurality of sorting holes having a different diameter, the coins being dropped to the sorting holes when the sorting holes are aligned with the conveying holes; and a coin receiving tube in which the coins dropped from the seating part are received and stacked.

In a still another further aspect of the present invention, there is provided a manual coin sorter comprising: a coin input part for inputting coins; a conveying container provided with a plurality of conveying holes on which coins inputted to the coin input part are disposed and conveyed; a coin input control part for allowing the coins inputted to the coin input part to be disposed by an appropriate amount on the conveying container; a drive part for rotating the conveying container using a user's external force; a seating part provided with a plurality of sorting holes each having a different diameter, the coins being dropped to the sorting holes when the sorting holes are aligned with the conveying holes; and a coin receiving tube in which the coins dropped from the seating part are received and stacked.

According to the present invention, the structure of the coin sorter becomes simple, reducing the size. In addition, the manufacturing costs can be saved. Furthermore, since the children can observe the sorting operation, the education effect can be obtained.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a coin sorter according to an embodiment of the present invention;

FIG. 2 is a sectional view taken along line I-I of FIG. 1;

FIG. 3 is a view illustrating a using state of a manual coin sorter according to the present invention;

FIG. 4 is a view illustrating a resorting of coins in a state where a use cover is opened from a manual coin sorter according to the present invention

FIG. 5 is a view illustrating a coin input control part for allowing the coins to be disposed on a conveying container by an appropriate amount according to a second embodiment of a manual coin sorter of the present invention;

FIG. 6 is a view illustrating a coin input control part for allowing the coins to be disposed on a conveying container by an appropriate amount according to a third embodiment of a manual coin sorter of the present invention; and

FIG. 7 is a view of a coin hooking projection according to a third embodiment of a manual coin sorter of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

### First Embodiment

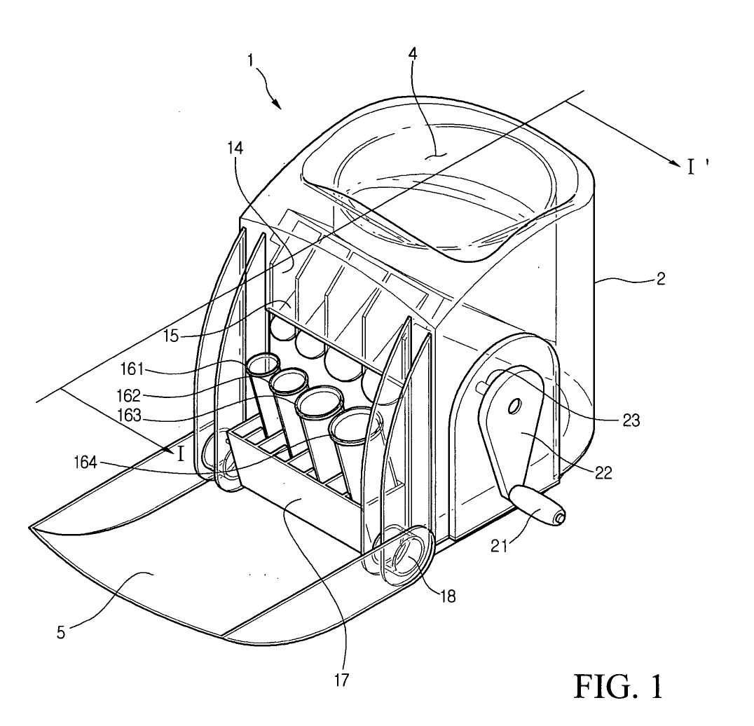

FIG. 1 shows a coin sorter according to an embodiment of the present invention.

Referring to FIG. 1, the inventive manual coin sorter 1 includes an outer case 2 defining an outer appearance of the coin sorter, a use cover 5 formed on a front side of the outer case 2, a hinge 18 for a pivotal motion of the use cover 5, a handle 21 formed on a side portion of the outer case 2 to allow a user to apply outer force, a rotating unit 22 rotated by the handle 21, and a rotational shaft connected to a central shaft of the rotating unit 22 to receive outer force.

The coin sorter 1 further includes a dropping guide 15 for guide the dropping of the sorted coins, a plurality of coin receiving tubes 161, 162, 163, and 164 formed under the dropping guide 15, a receiving container 17 for receiving the coin receiving tubes 161, 162, 163, 164, and barriers 14 for dividing the dropping guide 15 into a plurality of sections to prevent the sorted coins from being mixed. The divided sections of the dropping guide 15 are designed to correspond to the kinds of the coins.

The outer case 2 may be formed of transparent material so that the user can observe an internal structure and an operating state, thereby providing an education effect especially for children and improving the esthetic sense.

A coin sorting unit is formed on an inner-upper portion of the outer case 2.

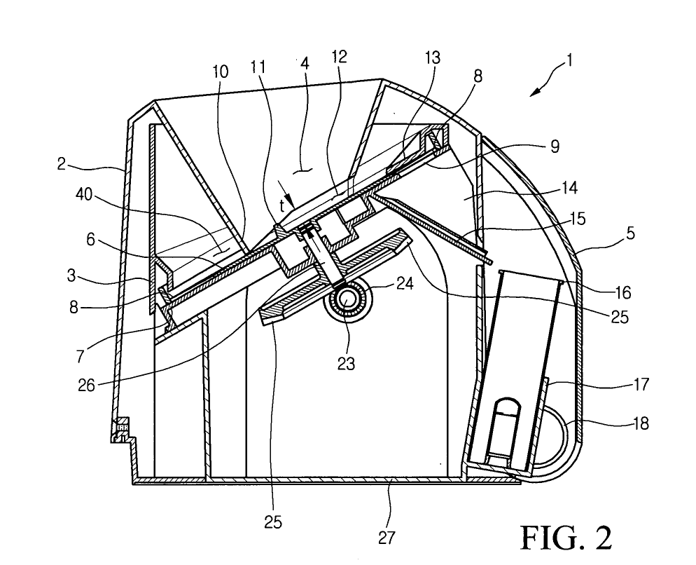

FIG. 2 shows a sectional view taken along line I-I of FIG. 1, illustrating an internal structure of the manual coin sorter according to the present invention.

The coin sorter 1 further includes a coin input part 4 concaved downward to input the coins, a coin conveying container 6 for conveying inputted coins one by one, a seating part 7 provided with sorting holes 9 through which the coins conveyed one by one by the conveying container 9 is dropped to each section of the dropping guide 15, and a driving shaft 26 for allowing the conveying container 6 to be rotated by outer force.

The driving shaft 26 is operated by the rotational shaft 23 rotated by the outer force applied by the user. That is, a first bevel gear 24 is formed on an end of the rotational shaft 23 and a second bevel gear 25 is engaged with the first bevel gear 24. The second bevel gear 25 is fixed to the driving shaft 26. Therefore, the outer force generated when the user rotates the handle 21 is transmitted to the conveying container 6 via the rotational shaft 23, the first bevel gear 24, the second bevel gear 25, and the driving shaft 26. An axis angle between the first and second bevel gears 24 and 25 is 90° so that the rotational force of the rotational shaft 23 can be accurately transmitted.

A coin input control part 10 is formed on a lower portion of the coin input part 4 to prevent the coins from being excessively fed to the conveying container 6. In order to feed a proper amount of coins to the conveying container 6, a coin hook projection 11 formed on an upper portion of the conveying container 6, and a coin passing part 12 formed with a predetermined width “t” between the coin input control part 10 and the conveying container 6 so that the coins hooked on the hooking projection 11 and conveyed can be dropped to the conveying container 6. The coin sorter may be erroneously operated when two or more coins are disposed on a conveying hole 8. In order to prevent this, a coin aligning part 13 is formed right above the sorting holes 9 so that coins disposed on the lowest coin can be hooked thereon and dropped into the conveying container 6. In addition, the coin aligning part 13 also serves to prevent a coin from slipping from other sorting hole 9, thereby preventing a mixture error of the different kinds of coins. That is, by the coin aligning part 13, only one coin horizontal disposed can be dropped through each of the sorting holes 9.

In addition, the number of sorting holes corresponds to the number of kinds of the coins. In order to effectively sort the coins, diameters of the sorting holes 9 are preferably decreased as they go frontward with respect to a rotational direction of the conveying container 6. By doing this, the malfunction of the sorter, which may be caused by the dropping of a small size coin through a large diameter hole 9, can be prevented.

There is further provided a coin receiving unit allowing the coins dropped through the sorting holes 9 to be received in an accurate location. That is, the coin receiving unit includes the dropping guide 15 having the sections corresponding to the kinds of the coins, the barriers 144 defining the sections, the coin receiving tubes 16 formed under the dropping guide 15, and the receiving container 17 for properly receiving the coin receiving tubes 16.

The operation of the above-described manual coin sorter according to the present invention will be described hereinafter.

When the user rotates the handle 21, the rotating unit 22 rotates. At this point, a bearing is disposed between the handle 21 and the rotating unit 22 so that the handle 21 can be smoothly rotated. When the rotating unit 22 rotates, the rotational force is transmitted to the conveying container 6 via the rotational shaft 23, the first bevel gear 24, the second bevel gear 25, and the driving shaft 26.

When the conveying container 6 is rotated, since the coin is hooked on the coin hooking projection 11, it moves to a side portion of the conveying container 6, after which it is dropped into the coin receiving space 40 through the coin passing part 12. Therefore, a proper amount of coins are inputted into the conveying container 6. The coin hooking projection 11 may be formed near the coin input control part 10 so that relatively many coins can be hooked thereon. However, the present invention is not limited to this.

In the above-described operation, the amount of coins dropped in the conveying container 6 is controlled by the coin input control part 10. In addition, by adjusting the width of the coin passing part 12, the amount of the coins that can be inputted into the coin receiving space 40 by a stroke of rotation can be adjusted.

The coin received in the coin receiving space 40 is conveyed to the sorting hole 9 as the conveying container 6 rotates in a state where the coin is seated in an inner space of the conveying hole 8. If two or more small coins are disposed on a single conveying hole 8, the excessively stacked coins are dropped by the coin aligning part 13 in the course of the coin conveying process. As a result, only one coin can be accurately sorted. The conveying container 6 is formed in a circular-shape so that it can be effectively conveyed.

When the coin being conveyed on the conveying hole 8 is disposed on the corresponding sorting hole 9 in the course of passing through the sorting hole 9, it is dropped to the dropping guide 15. Various kinds of the coins guided by the dropping guide 15 are received in the corresponding coin receiving tubes formed under the dropping guide. A predetermined amount of coins are received in the corresponding tube 16, the coins are separated from the receiving container 17 as a bundle state in the receiving tube 16.

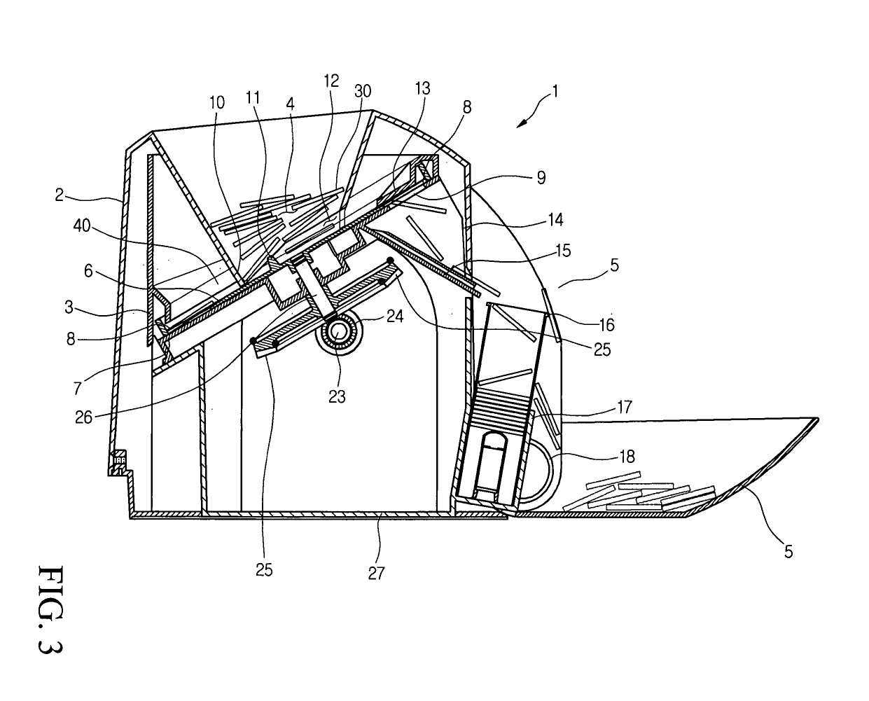

Meanwhile, when the coins are fully received in the corresponding receiving tube 16, following coins cannot be received in the tube 16. That is, the following coins are dropped out of the receiving tube 16 and collected in an inner space of the use cover 5. The coins collected in the use cover 5 are sorted again (see FIG. 3).

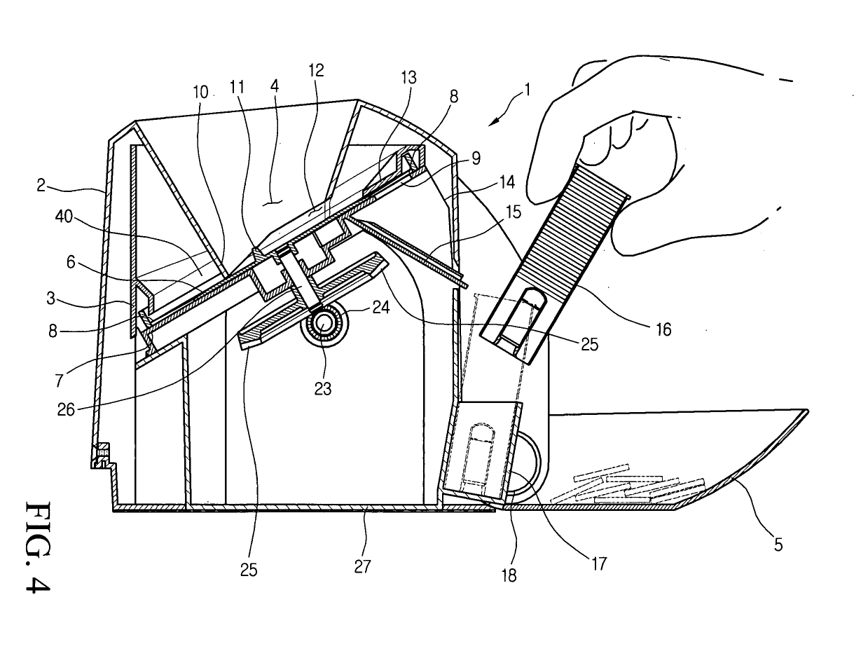

FIG. 3 illustrates a using state of a manual coin sorter according to the present invention, and FIG. 4 illustrates a resorting of coins in a state where the use cover is opened from a manual coin sorter according to the present invention.

Referring first to FIG. 3, when the user rotates the handle, the conveying container 6 rotates, by which an appropriate amount of coins 30 are conveyed to the coin receiving space 40. Then, the coins are dropped and stacked in the coin receiving tubes 16 through the sorting holes by size via the dropping guide 15.

Meanwhile, the coins inputted into the coin input part 4 stand by therein by being caught by the hooking projection 11 until they are conveyed to the coin passing part 12. In addition, they are fed to the coin receiving space 40 by a proper amount so that the sorter can be effectively operated by the conveying container 6.

The coins that are not normally received in the coin receiving tube 16 are dropped in a space defined by the use cover 5. For this, it is preferable that the sorter is used in a state where the use cover is opened.

The reference numeral 27 indicates a lower plate defining a bottom of the sorter. The receiving container is disposed on the lower plate 27.

FIG. 4 shows a state after the operation of the coin sorter is finished, in which the use cover 5 is opened. In this state, the dropped coins are collected in the receiving space formed by a bending portion of the user cover 5. The user withdraws the coins and feeds the withdrawn coins into the coin input part to sort the coins again.

Meanwhile, the coin receiving tubes 16 may be withdrawn from the receiving container 17. A wrap may be formed in the coin receiving tube 16. The wrap may be easily removed from the receiving tube 16 in a state where the coins are received in the tube 16.

As described above, the handle with the sliding bearing, which is manually operated, is mounted on a side of the sorter. By the rotation of the handle, the bevel gears disposed with a predetermined axis angle are rotated, by which the driving shaft connected to the bevel gear is rotated, thereby performing the sorting operation.

The conveying container and the seating part are not limited to the above described structure.

Furthermore, the bevel gears are also not limited to the above described structure. Instead of the bevel gears, other power transmission unit such as a belt may be used.

Since the coin sorter of the present invention is designed having a small volume, the user can more conveniently manipulate the same.

In addition, since the mechanical structure is simple, the manufacturing costs can be saved and the overall size can be reduced.

Furthermore, since the user can observe the operation state, the education effect for children can be improved.

### Second Embodiment

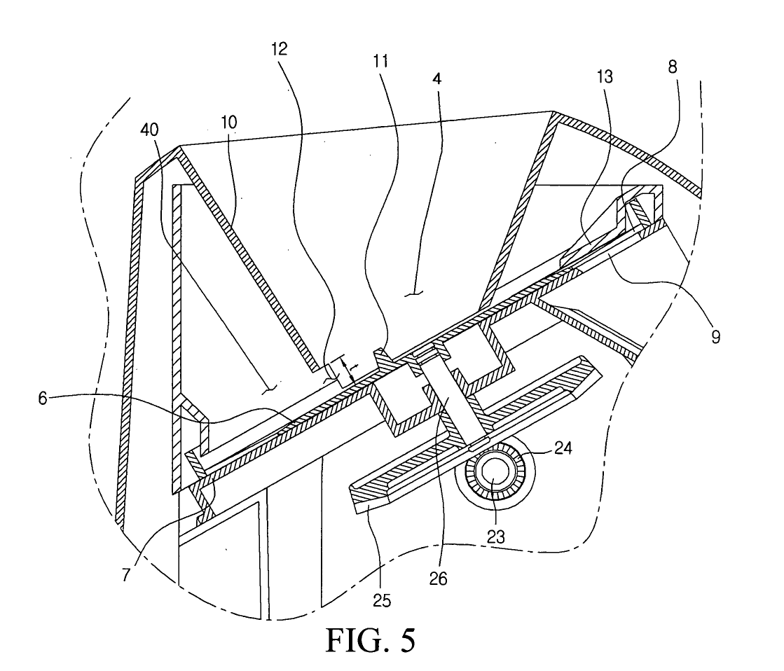

FIG. 5 is a view illustrating a coin input control part for allowing the coins to be disposed on a conveying container by an appropriate amount according to a second embodiment of a manual coin sorter of the present invention.

Referring to FIG. 5, a second embodiment of the present invention is different from the first embodiment in that the coin passing part 12 formed with a predetermined width “t” between the coin input control part 10 and the conveying container 6 is formed in a lower direction of the conveying container 6. Therefore, only a different part will be described below and descriptions of other parts, which are the same as those of the first embodiment, will be omitted.

According to the second embodiment of the present invention, the coin passing part 12 is formed in a lower direction of the conveying container 6, so that a predetermined amount of coins among the coins inputted to the coin input part 4 falls down into the coin receiving space 40 located in the lower direction of the conveying container 6 even when coins are hooked by the coin hooking projection 11 and not moved. That is, coins that are not hooked by the coin hooking projection 11 among the coins inputted to the coin input part 4 may be supplied to the conveying container 6, and coins that are hooked by the coin hooking projection 11 among the coins inputted to the coin input part 4 may not be supplied to the conveying container 6.

Therefore, it is possible not only to prevent the coins inputted to the coin input part 4 from being supplied to the conveying container 6 at a time, but also to allow a predetermined amount of coins among the coins inputted to the coin input part 4 to be directly supplied to the conveying container 6. Therefore, a predetermined amount of coins may be directly sorted for each size when the conveying container 6 is rotated by the driving shaft 26.

Also, to allow coins hooked by the coin aligning part 13 to drop into the conveying container 6, a width between the coin input control part 10 located in the upper direction of the conveying container 6 and the conveying container 6 may be greater than a thickness of a coin to be sorted. By doing so, the coins hooked by the coin aligning part 13 may be also continuously supplied to the conveying container 6 and sorted therein.

### Third Embodiment

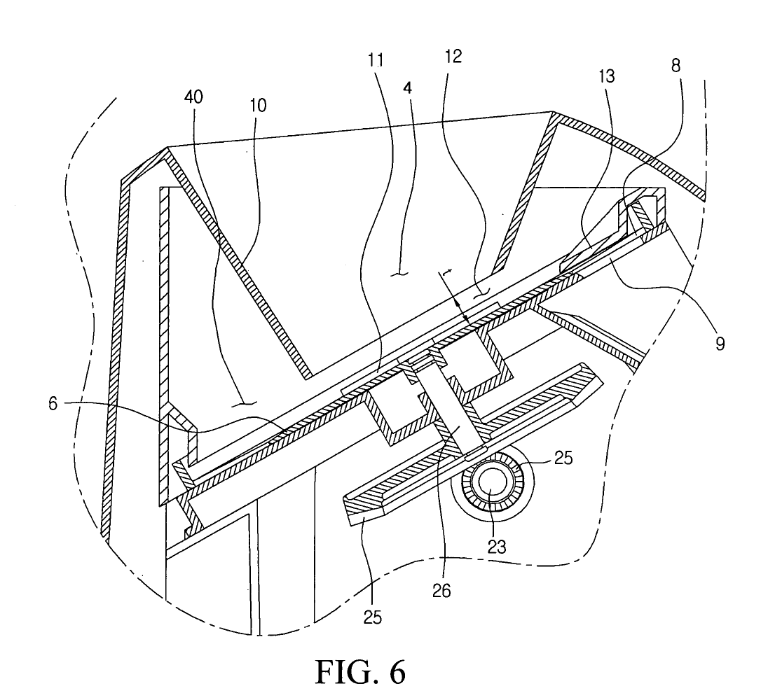

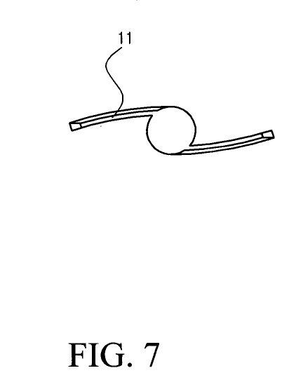

FIG. 6 is a view illustrating a coin input control part for allowing the coins to be disposed on a conveying container by an appropriate amount according to a third embodiment of a manual coin sorter of the present invention, and FIG. 7 is a view of a coin hooking projection according to a third embodiment of a manual coin sorter of the present invention.

Referring to FIGS. 6 and 7, a third embodiment of the present invention is different from the first embodiment in that the coin passing part 12 formed with a predetermined width “t” between the coin input control part 10 and the conveying container 6 is formed along an entire portion of the conveying container 6 and the coin hooking projection 11 has a different shape. Therefore, only different parts will be described below and descriptions of other parts, which are the same as those of the first embodiment, will be omitted.

According to the third embodiment of the present invention, the coin passing part 12 is formed along the entire length of the conveying container 6 to allow the coins inputted to the coin input part 4 to be swiftly supplied to the conveying container 6.

That is, coins that are not hooked by the coin hooking projection 11 among the coins inputted to the coin input part 4 may directly drop into the coin receiving space 40 located in the lower direction of the conveying container 4 through the coin passing part 12. Also, when the conveying container 6 is rotated, coins that are hooked by the coin hooking projection 11 are rotated together, and the coins may swiftly drop into the receiving space 40 through the coin passing part 12 formed along the entire length of the conveying container 6 due to centrifugal force. Therefore, the coins inputted to the coin input part 4 may be swiftly supplied to the conveying container 6.

Also, the width “t” of the coin passing part 12 may change depending on an interval between the coin input control part 10 and the conveying container 6. It is possible to control an amount of coins that may be delivered to the coin receiving space 40 using the coin passing part 12. Therefore, it is possible to control coins inputted to the coin input part 4 to be supplied by an appropriate amount to the conveying container 6.

Also, the coin passing part 12 may be formed in the upper direction of the conveying container 6 to allow coins hooked by the coin aligning part 13 to be easily supplied to the conveying container 6.

Referring to FIG. 7, the coin hooking projection 11 has a center coupled to the driving shaft 26 and two ribs extending along a tangential direction around the center. However, more than two ribs may be provided depending on the size of a coin to be sorted or the size of the conveying container 6.

A function of the coin hooking projection 11 will be described below in detail depending on modification of the shape thereof. As the driving shaft 26 is rotated, the coin hooking projection 11 coupled to the driving shaft 26 is rotated together, and the coins inputted to the coin input part 4 are hooked by the ribs extending in the tangential direction around the center of the coin hooking projection 11 and there rotated together. At this point, it is possible to allow the coins hooked by the ribs to be swiftly rotated by making the shapes of the ribs warped a little.

Therefore, the coins inputted to the coin input part 4 are scattered by the coin hooking projection 11 and may swiftly drop into the coin receiving space 40 through the coin passing part 12 formed along the entire length of the conveying container 6.

Also, even when the coins inputted to the coin input part 4 are tangled and the coins are not swiftly supplied to the conveying container 6, the tangled coins are scattered as the coin hooking projection 11 rotates, which allows the coins to be swiftly supplied to the conveying container 6.

Also, since a predetermined amount of coins among the coins inputted to the coin input part 4 is hooked by the coin hooking projection 11, it is possible to prevent the coins from being supplied to the conveying container 6 at a time.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A manual coin sorter comprising:
an outer case;
a handle operated by a user and formed on a side portion of the outer case;
a rotational shaft to which rotational force of the handle is transmitted;
a driving shaft to which rotational force of the rotational shaft is transmitted, the driving shaft is disposed with a predetermined axis angle with the rotational shaft;
a conveying container rotatably coupled to the driving shaft and provided with a plurality of conveying holes on which coins are disposed and conveyed;
a seating part provided with a plurality of sorting holes having a different diameter, the coins being dropped to the sorting holes when the sorting holes are aligned with the conveying holes; and
a coin receiving tube in which the coins dropped from the seating part are received and stacked.

2. The manual coin sorter according to claim 1, wherein the coins are conveyed from a lower side to an upper side by the conveying holes.

3. The manual coin sorter according to claim 1, wherein the handle revolves.

4. The manual coin sorter according to claim 1, further comprising a rotating unit, the rotational shaft being formed on a rotational center of the rotating unit and the handle is provided on an outer circumference of the rotating unit.

5. The manual coin sorter according to claim 1, further comprising a use cover pivotally coupled to the outer case to receive dropping coins.

6. The manual coin sorter according to claim 1, further comprising a bevel gear to which the rotation and driving shafts are connected.

7. The manual coin sorter according to claim 1, further comprising a coin input control part for allowing coins to be disposed by an appropriate amount on the conveying container.

8. The manual coin sorter according to claim 1, further comprising a coin input control part formed by a separated part and disposed above the conveying container.

9. The manual coin sorter according to claim 1, further comprising a coin hooking projection formed on a rotational location of the conveying container so that the coins can be hooked and conveyed when the conveying container rotates.

10. The manual coin sorter according to claim 1, further comprising a coin aligning part formed on an upper portion of the conveying container to align the coins stacked on the conveying hole.

11. A manual coin sorter comprising:
a handle rotatably installed on an outer case;
a rotational shaft rotated by the handle;
a driving shaft connected to the rotational shaft with a predetermined axis angle;
a coin sorting unit rotated by the driving shaft to sort the coins by size; and
a coin receiving unit for receiving the sorted coins.

12. The manual coin sorter according to claim 11, wherein the axis angle is 90°.

13. The manual coin sorter according to claim 1, wherein the rotational shaft is connected to the driving shaft by a bevel gear.

14. The manual coin sorter according to claim 11, wherein the rotational shaft slides with respect to the rotational shaft.

15. The manual coin sorter according to claim 11, further comprising a rotating unit, the rotational shaft being connected to a central portion of the rotating unit and the handle being connected to an outer circumference of the rotating unit.

16. The manual coin sorter according to claim 11, wherein the handle is disposed on a side surface of the outer case.

17. A manual coin sorter comprising:
a handle rotatably installed on an outer case;
a rotational shaft rotated by the handle;
a driving shaft connected to the rotational shaft with a predetermined axis angle;
a coin input part provided on an upper portion of the outer case;
a conveying container rotatably coupled to the driving shaft and provided with a plurality of conveying holes on which coins are disposed and conveyed;
a seating part provided with a plurality of sorting holes having a different diameter, the coins being dropped to the sorting holes when the sorting holes are aligned with the conveying holes; and
a coin receiving tube in which the coins dropped from the seating part are received and stacked.

18. The manual coin sorter according to claim 17, further comprising a coin hooking projection extending from a top of the conveying container into the coin input part.

19. The manual coin sorter according to claim 17, further comprising a coin input control part extending from a side portion of the coin input part to prevent the coins from being excessively inputted from the coin input part.

20. The manual coin sorter according to claim 17, wherein a predetermined gap is formed between a portion of the coin input part and the conveying container.

21. A manual coin sorter comprising:
a coin input part for inputting coins;
a conveying container provided with a plurality of conveying holes on which coins inputted to the coin input part are disposed and conveyed;
a coin input control part for allowing the coins inputted to the coin input part to be disposed by an appropriate amount on the conveying container;
a drive part for rotating the conveying container using a user's external force;
a seating part provided with a plurality of sorting holes each having a different diameter, the coins being dropped to the sorting holes when the sorting holes are aligned with the conveying holes; and
a coin receiving tube in which the coins dropped from the seating part are received and stacked.

22. The manual coin sorter according to claim 21, further comprising a coin passing part formed such that an entire lower end or a portion of the coin input control part is spaced a predetermined width from the conveying container.

23. The manual coin sorter according to claim 22, further comprising a coin hooking projection for allowing the coins inputted to the coin input part to be swiftly supplied to the conveying container through the coin passing part.

24. The manual coin sorter according to claim 21, further comprising a coin hooking projection projecting to an inner space of the coin input part from an upper surface of the conveying container.

25. The manual coin sorter according to claim 24, wherein the coin hooking projection comprises a center coupled to a driving shaft and a plurality of ribs extending in a tangential direction around the center.
